(19) United States
(12) Patent Application Publication
(10) Pub. No.: US 2005/0061008 A1
(43) Pub. Date: Mar. 24, 2005

(54) Method and apparatus for monitoring an air conditioning / refrigeration unit

(76) Inventors: A. Ben-Nakhi, Salmiya (KW); H. Hamouda, Cairo (EG); A. Elsaftawy, Cairo (EG); S. Elfeki, Ottawa (CA); A. Klaib, Tanta (EG)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/668,972

(22) Filed: Sep. 24, 2003

(51) Int. Cl. G01N 7/00; G01N 9/00

(52) U.S. Cl. 62/127; 73/23.2

(57) ABSTRACT

A monitoring system for an air conditioning/refrigeration unit is disclosed that includes a microprocessor and a plurality of inputs operatively connected to the microprocessor for receiving data from a plurality of sensors operatively connected to the air conditioning/refrigeration unit. A memory operatively connected to the microprocessor stores data describing a pressure enthalpy diagram for at least one refrigerant and a nominal pressure enthalpy path for the ACR unit being monitored. The microprocessor uses data received at the inputs for calculating an actual pressure enthalpy path for the ACR unit and displaying the calculated pressure enthalpy path and the nominal system pressure enthalpy path on a display. A method for monitoring an air conditioning/refrigeration system is also disclosed.

### FIELD OF THE INVENTION

The present invention is directed toward a method and apparatus for monitoring an air conditioning and refrigeration (ACR) unit, and more specifically, toward a method and apparatus for monitoring an ACR unit that includes a display of a pressure enthalpy path for the ACR unit to provide information on the operation of the unit.

### BACKGROUND OF THE INVENTION

Both air conditioning units and refrigeration units function by absorbing heat from a first location and transporting the heat to a second location where it is released. Air conditioning units are designed primarily to reduce the temperature of a living space to a comfortable temperature for its inhabitants. Refrigeration units are designed primarily to keep food and other items at an even lower temperature. However, both work according to the same basic principles and will be referred to jointly herein as air conditioning/refrigeration (ACR) units or ACR systems.

ACR systems are often run until they break down or until an obvious problem develops. The consequences of a malfunction can be very costly. For example, a large commercial refrigerator may hold thousands of dollars of food that will be rendered worthless if it is not maintained at a proper temperature. Even the cost of replacing food in a home refrigerator that fails can be substantial. Drugs and cultures in a laboratory refrigerator could be difficult and expensive to replace if refrigeration is lost, and computer equipment may malfunction if it is not maintained at a controlled temperature. Homes and businesses also become difficult or nearly impossible to occupy if an air conditioner fails during a hot period.

ACR systems generally work the hardest during the hottest times of the year. This also seems to be the time that such systems are likely to fail. The skilled technicians who generally service ACR systems are in high demand during such periods, and may not be able to service every ACR system that fails before expensive damage occurs. It may also be difficult to obtain the services of a skilled technician when a breakdown occurs outside of business hours or over the weekend.

Efforts have been made to monitor the performance of ACR systems and detect malfunctions before they render a system inoperable. For example, U.S. Pat. No. 5,729,474 to Hildebrand discloses a method of monitoring the time required by an air conditioner to reduce the temperature of a space from a first level to a second level—each day when the system is started, for example. Increases in this time may suggest a problem with the air conditioner. Such a method provides little information about the overall operation of an air conditioner, and, when a failure occurs, may tell a technician little except that the air conditioner was working before and is not working now. It would therefore be desirable to provide a system and method for monitoring an ACR system that provides detailed information about the operating status of the system in a manner that allows for an analysis of system operation and a determination of corrective steps that can be taken to prevent the system from failing, before a failure occurs.

### SUMMARY OF THE INVENTION

The above problems and others are addressed by the present invention which comprises, in a first embodiment, a monitoring system for an ACR unit. The system includes a microprocessor having inputs operatively connected to a plurality of sensors that provide data about the ACR system to the microprocessor. A memory stores data describing a pressure enthalpy diagram for at least one refrigerant and a nominal pressure enthalpy path for the ACR unit. The microprocessor uses data from the sensors for calculating an actual pressure enthalpy path for the ACR unit and displays the actual, calculated, pressure enthalpy path for the ACR unit on a display.

Another aspect of the invention comprises a method of measuring the performance of an ACR unit containing a refrigerant that involves the steps of measuring a plurality of characteristics of the ACR unit. These characteristics include refrigerant temperature at a first location and refrigerant pressure at a second location. A pressure enthalpy path for the ACR unit is calculated based on the measured characteristics. The pressure enthalpy curve for the refrigerant and the calculated pressure enthalpy path of the unit are then displayed.

A further aspect of the invention comprises a portable monitoring system for an ACR unit that includes a microprocessor having a plurality of data inputs and a plurality of sensors connected to the ACR unit and operatively connected to the plurality of inputs. A memory operatively connected to the microprocessor stores data describing a pressure enthalpy diagram for at least one refrigerant and a nominal pressure enthalpy path for the ACR. The portable monitoring system further includes an artificial neural network and a display. The microprocessor uses data received at the inputs to calculate an actual pressure enthalpy path for the ACR unit and display the nominal pressure enthalpy path for the ACR unit and the actual pressure enthalpy path for the ACR unit. Furthermore, using the data from the sensors, at least one other characteristic of the ACR unit is calculated, and this characteristic may be: refrigerant effect, amount of heat rejected to the condenser, compressor work performed, degree of superheating, degree of sub-cooling, percentage of flash gasses, coefficient of performance, and pressure drop between various points in the system.

Another aspect of the invention comprises a monitoring system for an ACR unit that includes a microprocessor device having a memory and a mechanism for obtaining data describing the ACR unit. Data describing a pressure enthalpy diagram for a refrigerant and a nominal pressure enthalpy path for the ACR unit are stored in the memory. A mechanism for graphically displaying a pressure enthalpy path is also provided. In operation, the microprocessor device calculates from the obtained data a description of an actual pressure enthalpy path for the ACR unit and causes the nominal pressure enthalpy path and the actual pressure enthalpy path for the ACR unit to be displayed on the graphical display device.

### BRIEF DESCRIPTION OF THE DRAWINGS

The present invention will be better appreciated after a reading of the following detailed description thereof together with the following drawings of which:

FIG. 1 is a side elevational view of a ACR monitoring device according to the present invention connected to an ACR system, which is shown schematically;

FIG. 2 is a pressure enthalpy diagram for a first refrigerant;

FIG. 3 is a pressure enthalpy path for an ACR unit superimposed on the pressure enthalpy diagram of FIG. 2;

FIG. 4 is a perspective view of the ACR monitoring device of FIG. 1;

FIG. 5 is a detail view of circle V in FIG. 4 showing the display generated by the ACR monitoring device and ACR system of FIG. 1; and

FIG. 6 is a flow chart showing a method of monitoring an ACR system according to the present invention.

### DETAILED DESCRIPTION OF THE INVENTION

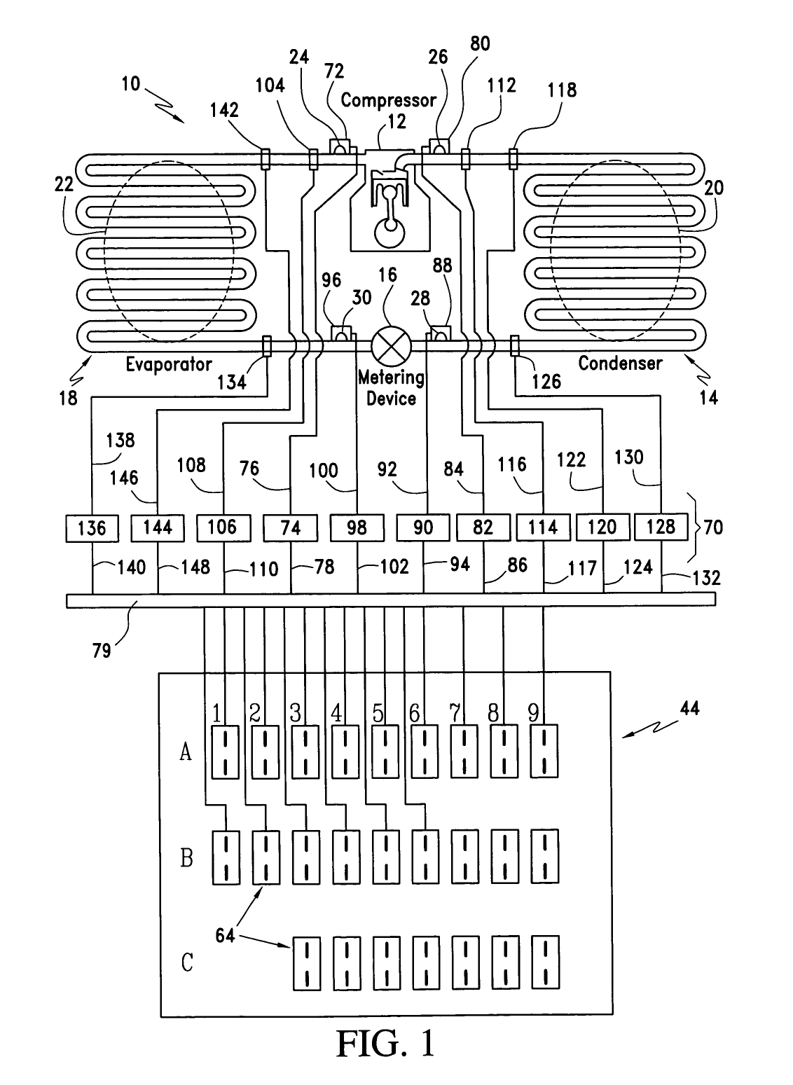

Referring now to the drawings, wherein the showings are for the purpose of illustrating a preferred embodiment of the invention only and not for the purpose of limiting same, FIG. 1 shows an ACR system 10 comprising a compressor 12, a condenser 14, a metering device 16, an evaporator 18, a condenser fan 20 and an evaporator fan 22 for moving air across the condenser 14 and evaporator 18 respectively. Refrigerant flows through the system 10 in the direction from compressor 12 toward condenser 14, and the terms “upstream” and “downstream” as used herein are in relation to this direction of flow. System 10 further includes several ports at which refrigerant pressure can be measured, including a first port 24 immediately upstream of compressor 12, a second port 26 immediately downstream of compressor 12, a third port 28 upstream of metering device 16 and a fourth port 30 downstream of metering device 16.

System 10 operates as follows. High pressure liquid refrigerant in condenser 14 passes through a small opening in metering device 16 which causes the pressure of the liquid to drop. The refrigerant is selected so that, at the normal operating temperature of the unit, the boiling point of the liquid will fall below ambient temperature during the pressure drop through metering device 16. Any liquid that does not immediately vaporize during the pressure drop does so in evaporator 18. A significant amount of heat is absorbed from the air surrounding evaporator 18 when the refrigerant evaporates, and relatively warm, low pressure vapor exits evaporator 18. This vapor moves to compressor 12 where it is compressed, thereby lowing its boiling point. The process of compression also adds heat to the refrigerant. The generally warm, high pressure gas passes through condenser 14 where heat is removed from it, by fan 20 blowing air over condenser 14, for example. This cooling causes the vapor in condenser 14 to condense into a liquid, under pressure, which is fed to metering device 16 where the cycle begins again. The evaporator 18 is generally located in a first closed location separate from the condenser 14 so that heat absorbed from the air surrounding evaporator 18 is effectively transferred to a location outside the closed location surrounding evaporator 18.

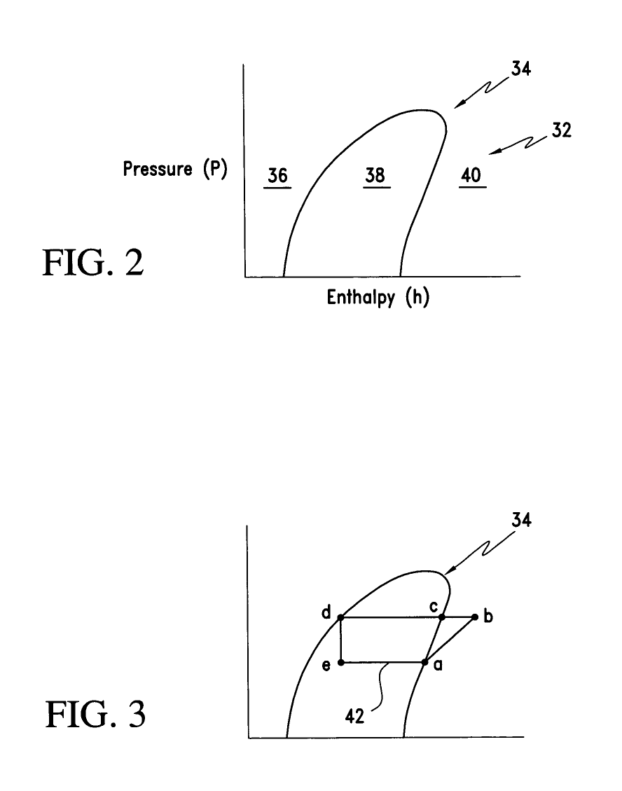

The enthalpy or heat content of a refrigerant varies with the pressure of the refrigerant. Different combinations of pressure (P) and enthalpy (h) will cause the refrigerant to exist in a liquid state, a vapor state, or a combination of the two. The relationship between the pressure and enthalpy of a material can be shown by using a pressure enthalpy, or P-h, diagram. A simplified pressure enthalpy diagram 32 for a refrigerant is shown in FIG. 2. On diagram 32, pressure increases from the bottom to the top of the vertical axis of the diagram while enthalpy increases from left to right along the horizontal axis. The curve 34 separates the diagram into three regions. A first region 36 lies to the left of curve 34. Under the combinations of temperatures and pressures represented by this portion of diagram 32, the refrigerant will exist in a liquid state. In the second region 38 located under the curve 34, the refrigerant will exist as a combination of liquid and vapor. The third region 40 lies to the right of curve 34. Under the combinations of temperatures and pressures represented by this portion of the diagram, the refrigerant will exist in a vapor state. Curve 34 represents the limiting conditions under which the material can exist as entirely liquid (along the left side thereof as viewed in FIG. 2) or entirely vapor (along its right side).

Liquids in first region 36 are said to be sub-cooled. In other words, the liquid exists at a temperature below its boiling point for the pressure level specified on the diagram. The difference between the temperature of the liquid and its boiling point at a given pressure is referred to as its degree of sub-cooling. Water at 95° C., at 1 atmosphere, for example, has a degree of sub-cooling of 5°. Vapor in the third region 40 is said to be superheated. In other words, the vapor exists at a temperature above the temperature at which the vapor would begin to condense. Water vapor at 110° C. would therefore be described as having a degree of superheating of 10°. Different materials generally will have different temperature enthalpy diagrams.

The physical state of the refrigerant traveling around an ACR system can be shown using a pressure enthalpy path superimposed on a pressure enthalpy diagram to allow the refrigeration cycle to be visualized. An idealized pressure enthalpy path 42 for an ACR system is shown in FIG. 3 superimposed on the pressure enthalpy diagram 32 of FIG. 2. This path helps illustrate how the physical state of the refrigerant changes from liquid to vapor and back to liquid as the pressure and enthalpy of the system change.

Starting at point a, the pressure of a refrigerant increases as it is compressed by a compressor. Its enthalpy also increases. The increases in pressure and enthalpy are shown by the line between points a and b in FIG. 3. Point b lies to the right of curve 34 indicating that the refrigerant at this point is superheated; heat must be removed from it before it will begin to condense. The superheated vapor looses heat between points b and c on path 42, and the vapor begins to condense at point c on curve 34. The pressure remains constant during the condensation process, and at point d, the refrigerant is fully in liquid form. The pressure under which the refrigerant is held is decreased between points d and e on path 42. Heat is not added to or removed from the system during this pressure decrease, and the enthalpy of the system does not change; however, the temperature of the refrigerant drops. During the evaporation phase, shown between points e and a on the path, the pressure of the refrigerant remains constant while its enthalpy increases. When the refrigerant is fully evaporated at point a, it enters the compressor to begin the cycle again.

The above description represents an idealized refrigeration cycle. Heat gains and losses between the system and the ambient air, for example, will cause the pressure enthalpy path for a given ACR to deviate somewhat from this ideal path.

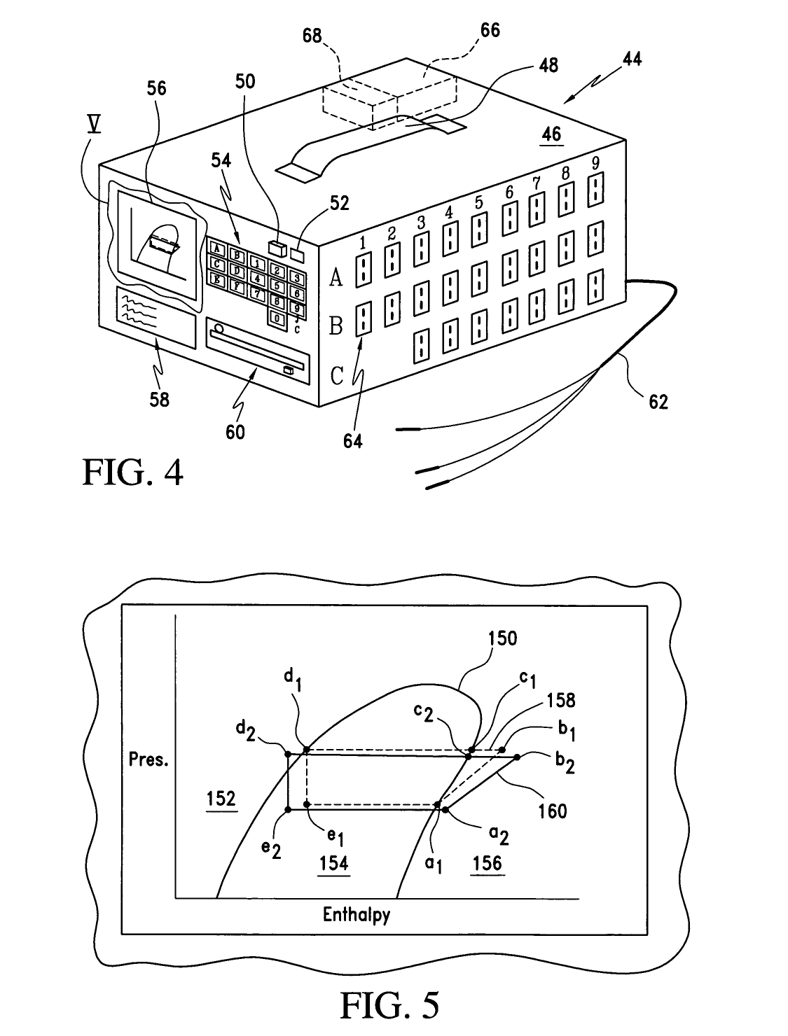

FIGS. 1 and 4 depict an ACR monitoring device 44 according to the present invention which comprises a housing 46 having a handle 48 for portability. As used herein, the term “monitoring” can refer both to ongoing monitoring of a system and short term monitoring of a system, for diagnostic purposes, for example. Device 44 further includes an on/off switch 50, a power indicator light 52, a hexadecimal keyboard 54, a graphic display screen 56 and an LCD display 58. Device 44 is also provided with a removable storage device 60 such as a floppy disk drive, and includes cables 62 for connecting the device to a power source (not shown). Twenty five socket inputs 64 are also provided for connecting sensors described herein. Sockets 64 are arranged in three rows labeled A, B and C and nine columns labeled 1-9. Particular sockets 64 are identified herein by their location in these rows and columns by a pair of coordinates. For example, the upper, left most socket, as viewed in FIG. 1, is identified as socket 64-A1.

Device 44 also includes a microprocessor 66 having a memory 68. Microprocessor 66 is operatively connected to display screen 56 and LCD display 58 and generates graphical and/or text output to the display screen 56 and LCD display 58. Microprocessor 66 is also operatively connected to input sockets 64 for receiving input from sensors connected to the ACR unit.

A plurality of pressure sensors and temperature sensors are connected to various parts of ACR system 10. Each of these sensors is connected to one of a plurality of data acquisition cards 70, which cards convert temperature and pressure information into digital signals usable by a microprocessor. Preferably, data acquisition card 70 include inputs having over voltage protection up to +/−35V and conversion rate ranges from 0.5 Hz to 250 kHz with selectable time intervals At that can be software controlled. Triggering and sampling is controlled by the hardware on the card. The card used might also have the following sampling modes: 1) individual sampling of various channels, 2) alternate sampling of all or a subset of channels, 3) the ability to accommodate signal edge or threshold value triggering, 4) adjustable pre-triggering with a recording depth of about 16,000 values, and 5) sampling at software controlled intervals.

Additionally, the data acquisition card is capable of 250 kS/s multifunction data acquisition and has a 32 bit VXD driver and a kernel driver for Microsoft Windows NT and Windows 2000 or Windows XP operating systems, 12 bit ADC with 16 single-ended or 8 differential analogue input channels with trigger and pre-trigger functions, a built in anti-aliasing filter and unipolar and bipolar input ranges. The data acquisition card is capable of single ended or differential operation and includes software controllable ranges and operation modes. The card 70 further includes digital I/O ports, is TTL compatible and has a maximum current of 4 mA. Suitable data acquisition cards are available, for example, from Keithley Instruments, Inc. of Cleveland, Ohio and from Agilent Technologies of Palo Alto, Calif. The use and operation of these cards is well known and will not be described further herein.

Data from the data acquisition cards 70 is fed to microprocessor 66 running MATLAB software that includes the MATLAB Data Acquisition Toolbox. These programs are available from The Mathworks of Natick, Mass. These utilities allow data to be stored, manipulated and graphed in a user-defined manner.

Referring again to FIG. 5, a first pressure sensor 72 is connected to first port 24 and connected to a first data acquisition card 74 via a cable 76. First data acquisition card 74 is connected to socket input 64-A1 of device 44 by a second cable 78 connected to a bus 79. Bus 79 is preferably an IEEE 488 (GPIB) bus. A second pressure sensor 80 is connected to second port 26 and connected to a second data acquisition card 82 via cable 84. Second data acquisition card 82 is connected to socket input 64-A2 via a cable 86 connected to bus 79. A third pressure sensor 88 is connected to third port 28 and connected to a third data acquisition card 90 via cable 92. Third data acquisition card 90 is connected to socket input 64-A3 via a cable 94 connected to bus 79. A fourth pressure sensor 96 is connected to fourth port 30 and connected to a fourth data acquisition card 98 via cable 100. Fourth data acquisition card 98 is connected to socket input 64-A4 via a cable 102 connected to bus 79.

Temperature sensors are also connected to socket inputs of device 44 as follows. A first temperature sensor 104 is connected to the ACR system immediately upstream of compressor 12 and to a fifth data acquisition card 106 via a cable 108. Fifth data acquisition card 106 is connected to input socket 64-B1 via cable 110 connected to bus 79. A second temperature sensor 112 is connected to ACR system 10 just downstream of compressor 12 and to a sixth data acquisition card 114 via a cable 116. Sixth data acquisition card 114 is connected to input socket 64-B2 via cable 117 connected to bus 79. A third temperature sensor 118 is connected to the ACR system at the upstream side of condenser 14 and to a seventh data acquisition card 120 via a cable 122. Seventh data acquisition card 120 is connected to input socket 64-B3 via cable 124 connected to bus 79. A fourth temperature sensor 126 is connected to the ACR system at the downstream side of condenser 42 and to a eighth data acquisition card 128 via a cable 130. Eighth data acquisition card 128 is connected to input socket 64-B4 via cable 132 connected to bus 79. A fifth temperature sensor 134 is connected to the ACR system at the upstream side of evaporator 18 and to an eighth data acquisition card 136 via a cable 138. Eighth data acquisition card 136 is connected to input socket 64-B5 via cable 140 connected to bus 79. A sixth temperature sensor 142 is connected to the ACR system at the downstream side of evaporator 18 and to a ninth data acquisition card 144 via a cable 146. Ninth data acquisition card 144 is connected to input socket 64-B6 via cable 148 connected to bus 79.

While a separate data acquisition card has been shown for connecting each sensor to device 10, data acquisition cards capable of handling several channels of input may be used to reduce the number of system components. Likewise, while the various connections described above are made with cables, other types of connectors, including radio frequency transmitters and receivers could also be employed for transferring data from sensors to data acquisition cards and/or from data acquisition cards to device 10.

In use, a pressure enthalpy curve 150 for the refrigerant used in ACR system 10 is plotted on screen 56 (shown enlarged in FIG. 5). Pressure enthalpy curves for more than one refrigerant may be stored in memory 68, and the appropriate refrigerant selected at the start of monitoring. Pressure enthalpy curve 150 defines three regions, a first region 152 which represents combinations of pressure and enthalpy under which the refrigerant is entirely in a liquid state, a second region 154 which represents combinations of pressures and enthalpies under which the refrigerant is a mixture of liquid and vapor, and a third region 156 which represents combinations of pressures and enthalpies under which the refrigerant is entirely in a vapor state. Also on screen 56 is plotted a nominal pressure enthalpy path 158, shown in dashed lines, which shows the pressures and enthalpies the refrigerant should ideally have as it circulates through ACR system 10. This information is obtained from the manufacturer of the ACR system or, optionally, could be derived from measurements taken on the ACR system when it began operation or was otherwise known to be operating normally.

Nominal pressure enthalpy path 158 includes point a₁ representing the pressure and enthalpy the refrigerant should have as it enters compressor 12, point b₁ representing the pressure and enthalpy the refrigerant should have as it leaves the compressor, point c₁ representing the pressure and enthalpy the refrigerant should have at the point it begins to condense, point d₁ showing the pressure and enthalpy the refrigerant should have as it enters metering device 16 and point e₁ showing the pressure and enthalpy the refrigerant should have as it exits the metering device.

An actual pressure enthalpy path 160 is also displayed on screen 56. Actual pressure enthalpy path 160 is plotted from the data provided by the pressure and temperature sensors connected to the ACR system. Actual pressure enthalpy path 160 includes a point a₂ representing the actual pressure and enthalpy of the refrigerant as it enters the compressor, point b₂ representing the actual pressure and enthalpy of the refrigerant as it leaves the compressor, point c₂ representing the actual pressure and enthalpy of the refrigerant when it begins to condense, point d₂, representing the actual pressure and enthalpy of the refrigerant when it arrives at the metering device 16 and point e₂ representing the actual condition of the refrigerant when it leaves the metering device 16.

As can be seen in FIG. 5, the actual pressure enthalpy path 160 is not identical to the nominal pressure enthalpy path 158. The differences between paths 158 and 160 helps a technician diagnose various problems with the ACR system. For example, the enthalpy at point e₂ is greater than the nominal enthalpy e₁. This shows that refrigerant is arriving at compressor 12 at a higher than normal temperature and may suggest, for example, that evaporator fan 22 is not removing sufficient heat from the refrigerant in evaporator 18. Likewise, the vertical separation between points a₂ and a₁ suggests that insufficient pressure is being created in the compressor, possibly indicative of a failing compressor. Many other problems and potential problems with an ACR system can be recognized by a technician using such a system.

Other useful quantities describing the system can also be calculated and displayed on display 56 once the data for generating the pressure enthalpy path of FIG. 5 has been acquired. These quantities can also be compared to nominal values stored in the system to detect changes indicative of abnormal system operation. These characteristics can be used along with the pressure enthalpy path for the ACR device 10 to analyze the performance of the system. These characteristics include:

Refrigeration effect, or the amount of heat absorbed by the evaporator, is shown as the difference in enthalpy at points d and e.

Heat of rejection, or the amount of heat given up by the condenser, is shown by the difference in enthalpies at points b and d.

Heat of Compression, or the increase in enthalpy caused compressing a vapor in the compressor, is shown by the horizontal separation between points a and b on the path.

Degree of Superheating, or the amount by which the temperature of the vapor is increased beyond the vapor saturation point, is shown by the spacing between point b and the pressure enthalpy curve.

Degree of Sub-cooling, or the amount by which the temperature of the refrigerant is decreased below its liquid saturation point, is shown by the distance between point d and the pressure enthalpy curve.

Percentage of Flash gases. Immediately downstream of a metering device, high pressure liquid refrigerant will change into a flash gas, that is, a supercooled gas. As the flash gas absorbs heat, it will turn into vapor.

Coefficient of Performance, or the ratio of the Refrigeration Effect to work input to the system. The work input to the system is the difference between the heat rejected by the condenser and the heat supplied to the evaporator.

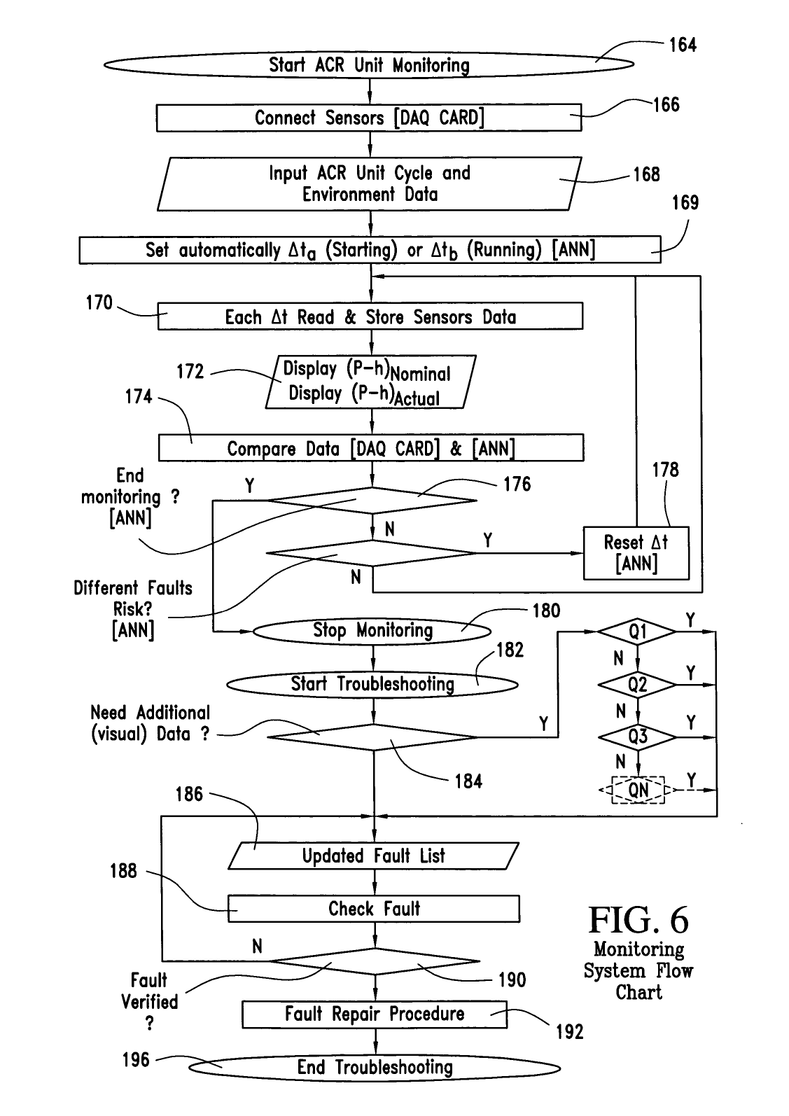

FIG. 6 illustrates the operation of the monitoring device 44. Monitoring of the system begins at step 164, and at step 166 sensors are connected to various parts of ACR system 10. At step 168, information concerning ACR system 10 is input into device 44 along with relevant environmental data such as ambient temperature. Monitoring time periods Δt are next established at step 169. Two such periods are relevant. First, Δtₐ, a monitoring interval for immediately after system startup is set. Next, Δt_{b}, or a monitoring interval for all times after startup is set. Current drawn by the compressor and other variables may be monitored by system 44, and these variables, as well as temperature and pressure variables may change relatively quickly immediately after startup. Setting a relatively short Δtₐ allows for changes occurring at startup to be observed, while a longer Δt_{b} after startup prevents overloading the system with data that is changing at a slower rate, if at all, after the system has reached an equilibrium operating state.

At step 170, readings are taken from sensors at the established time period, and the data is stored in memory 68. At step 172, a nominal pressure enthalpy path and actual pressure enthalpy path are displayed on display 56, and the two paths are compared at step 174. At step 176, an operator must determine whether to stop monitoring system 10 or continue monitoring using different Δt values in order to look for different types of system faults. If additional monitoring is needed, Δt values are reset at step 178, and the system returns to step 170 to take additional readings using the new time intervals Δt.

If, at step 176 the operator decides to stop monitoring the system, monitoring is stopped at step 180 and troubleshooting begins at step 182. The operator is prompted for additional data if necessary to diagnose certain types of problems. For example, the operator may be prompted at steps 184 to enter information concerning the age of the ACR system or the conditions under which it is normally operated or other information that is not generally obtainable from a sensor. This information helps the device 44 assess the likelihood of various system problems and suggest appropriate repairs using artificial intelligence or artificial neural network software, for example. A knowledge base of faults, their symptoms and appropriate repairs may be stored locally or device 44 may be connectable to the Internet to allow a larger, centralized knowledge base to be consulted. A fault list is established at step 186 which comprises a list of potential problems with the system, and each of the potential faults are checked, either by a technician or by analyzing additional system data, at step 188. If the first fault is found to exist at step 190, the technician proceeds to order or perform the necessary repair. If the fault is not present, the next fault on the fault list is checked at step 192. Troubleshooting ends at step 196.

The present system can beneficially be used with the Neural Network Toolbox available from the Mathworks as a compliment to the MATLAB software running on microprocessor 66. This software collects and analyzes data and learns to diagnose future ACR system problems based on the data input and faults determined at initial stages by technicians. For example, a certain problem indicated by the nominal and actual pressure enthalpy paths may suggest one of two fault conditions. However, one of the fault conditions may be much more likely for systems having compressors that are more than ten years old. This type of information would allow the device 44 to more quickly determine the problem with a later-analyzed system. In addition, such neural networks may help a technician become aware of other sets of conditions that indicate a system problem based on the amount of data collected from numerous systems.

The present invention has been described in terms of a preferred embodiment. However, various additions and modifications to the preferred embodiment will become apparent to those skilled in the relevant arts upon a reading and understanding of the foregoing detailed description. For example, while the present invention relies primarily upon refrigerant temperature and pressure measurements, device 10 could also obtain additional system data from additional sensors. For example, current drawn by the compressor could be monitored as could compressor and evaporator fan speed. Making these other variables available to the system, especially when the neural network software is run, will lead to improved diagnostic accuracy. It is intended that all such obvious modifications and additions to the system comprise a part of this invention to the extent they fall within the scope of the several claims appended hereto.

1. A monitoring system for an ACR unit comprising:
a microprocessor;
a plurality of inputs operatively connected to said microprocessor and adapted to receive data from a plurality of sensors operatively connected to the ACR unit;
a memory operatively connected to said microprocessor storing data describing a pressure enthalpy diagram for at least one refrigerant and a nominal pressure enthalpy path for the ACR unit; and
a display;
wherein said microprocessor uses data received at said inputs for calculating an actual pressure enthalpy path for the ACR unit.

2. The monitoring system of claim 1 wherein said microprocessor causes the nominal pressure enthalpy path for the ACR unit to be shown on said display.

3. The monitoring system of claim 1 wherein said microprocessor causes the actual pressure enthalpy path for the ACR unit to be shown on said display.

4. The monitoring system of claim 1 wherein said microprocessor causes the nominal pressure enthalpy path for the ACR unit and the actual pressure enthalpy path for the ACR unit to be shown concurrently on said display.

5. The monitoring system of claim 4 wherein said microprocessor calculates from said data at least one other characteristic of the ACR unit, said ACR unit comprising a compressor, a condenser and an evaporator, wherein said at least one other characteristic is selected from the group consisting of: refrigerant effect, amount of heat rejected to the condenser, compressor work performed, degree of refrigerant superheating, degree of refrigerant sub-cooling, percentage of flash gasses, coefficient of performance, and pressure drop in a system line.

6. The monitoring system of claim 1 including an artificial neural network connected to said microprocessor.

7. A method of measuring the performance of an ACR unit containing a refrigerant comprising the steps of:
measuring a plurality of characteristics of the ACR unit including refrigerant temperature at a first location and refrigerant pressure at a second location;
calculating a pressure enthalpy path for the ACR unit based on the measured characteristics; and
graphically displaying a pressure enthalpy curve for the refrigerant and the calculated pressure enthalpy path of the unit.

8. The method of claim 7 including the additional step of displaying a nominal pressure enthalpy path for the ACR unit.

9. The method of claim 8 including the additional step of displaying a nominal pressure enthalpy path for the ACR unit concurrently with the calculated pressure enthalpy curve.

10. The method of claim 8 including the additional step calculating at least one additional characteristic of the ACR unit, wherein the ACR unit comprises a compressor, a condenser and an evaporator, the at least one additional characteristic selected from the group consisting of: refrigerant effect, amount of heat rejected to the condenser, compressor work performed, degree of refrigerant superheating, degree of refrigerant sub-cooling, percentage of flash gasses, coefficient of performance, and pressure drop in a system line.

11. The method of claim 10 including the additional step of determining the operational status of the ACR unit.

12. The method of claim 11 including the additional step of diagnosing potential malfunctions of the ACR unit before they occur.

13. A portable monitoring system for an ACR unit comprising a compressor, a condenser and an evaporator, the system comprising:
a microprocessor having a plurality of data inputs;
a plurality of sensors connected to the ACR unit and operatively connected to said plurality of data inputs;
a memory operatively connected to said microprocessor storing data describing a pressure enthalpy diagram for at least one refrigerant and a nominal pressure enthalpy path for the ACR unit;
an artificial neural network connected to said microprocessor; and
a display;
wherein said microprocessor uses data received at said data inputs for calculating an actual pressure enthalpy path for the ACR unit and causes the nominal pressure enthalpy path for the ACR unit and the actual pressure enthalpy path for the ACR unit to be shown concurrently on said display, and wherein the said microprocessor calculates from said data at least one additional characteristic of the ACR unit selected from the group consisting of: refrigerant effect, amount of heat rejected to the condenser, compressor work performed, degree of refrigerant superheating, degree of refrigerant sub-cooling, percentage of flash gasses, coefficient of performance, and pressure drop in a system line.

14. A monitoring system for an ACR unit comprising:
microprocessor means including memory means;
means for obtaining values of a plurality of characteristics of the ACR unit operatively connected to said microprocessor means;
data describing a pressure enthalpy diagram for a refrigerant and a nominal pressure enthalpy path for the ACR unit stored in said memory means; and
means for graphically displaying a pressure enthalpy path;
wherein said microprocessor means calculates from the values a description of an actual pressure enthalpy path for the ACR unit and causes the nominal pressure enthalpy path and the actual pressure enthalpy path for the ACR unit to be displayed on the means for graphically displaying a pressure enthalpy path.

15. The monitoring system of claim 14 including diagnosing means for diagnosing a malfunction of the ACR unit.

16. The monitoring system of claim 14 including predicting means for predicting a malfunction of the ACR unit before a malfunction occurs.
